(19) United States
(12) Patent Application Publication
(10) Pub. No.: US 2026/0103285 A1
(43) Pub. Date: Apr. 16, 2026

(54) SERIES TURBINE SIMPLE CYCLE WITH INTEGRATED FLOW MULTIPLIER

(71) Applicant: Hamilton Sundstrand Corporation, Charlotte, NC (US)

(72) Inventors: Mark G. Vignali, Simsbury, CT (US); Aiden Coutin, Ogden, UT (US)

(21) Appl. No.: 19/352,086

(22) Filed: Oct. 7, 2025

Related U.S. Application Data
(60) Provisional application No. 63/705,684, filed on Oct. 10, 2024.

(51) Int. Cl. B64D 13/08; B64D 13/06

(52) U.S. Cl. CPC B64D 13/08; B64D 2013/0618

(57) ABSTRACT

An air conditioning system of a vehicle includes a first inlet for receiving a first medium, a second inlet for receiving a second medium, and a thermodynamic device fluidly connected to both the first inlet and the second inlet. The thermodynamic device includes a compressor and at least one turbine operably coupled by a shaft. An exhaust bypass conduit is fluidly connected to the compressor outlet of the compressor. A surge relief valve is associated with the exhaust bypass conduit and a position of the surge relief valve is adjustable to control a flow of the second medium exhausted overboard via the exhaust bypass conduit.

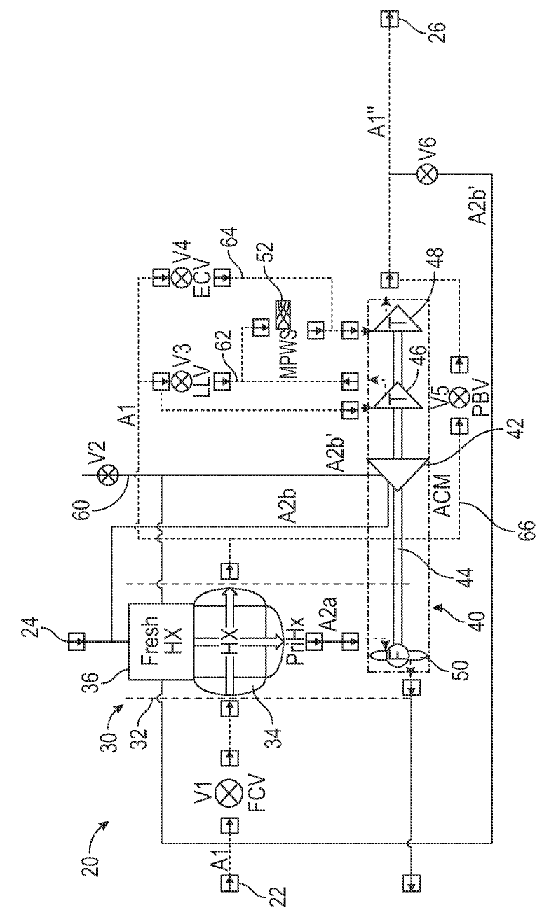

### CROSS-REFERENCE TO RELATED APPLICATIONS

This application claims the benefit of priority to U.S. Application No. 63/705,684 filed October 10, 2024, the disclosure of which is incorporated herein by reference in its entirety.

### BACKGROUND

Embodiments of the disclosure relate to environmental control systems, and more specifically to an air conditioning system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### BRIEF DESCRIPTION OF THE DRAWINGS

The subject matter is particularly pointed out and distinctly claimed in the claims at the conclusion of the specification. The foregoing and other features, and advantages thereof are apparent from the following detailed description taken in conjunction with the accompanying drawings in which:

The Figure is a schematic diagram of an environmental control system according to an embodiment.

### SUMMARY

According to an embodiment, an air conditioning system of a vehicle includes a first inlet for receiving a first medium, a second inlet for receiving a second medium, and a thermodynamic device fluidly connected to both the first inlet and the second inlet. The thermodynamic device includes a compressor and at least one turbine operably coupled by a shaft. An exhaust bypass conduit is fluidly connected to the compressor outlet of the compressor. A surge relief valve is associated with the exhaust bypass conduit and a position of the surge relief valve is adjustable to control a flow of the second medium exhausted overboard via the exhaust bypass conduit.

In addition to one or more of the features described herein, or as an alternative, in further embodiments the air conditioning system includes an outlet. In a first mode of operation, only the first medium is provided to the outlet and in a second mode of operation, a mixture of both the first medium and the second medium is provided to the outlet.

In addition to one or more of the features described herein, or as an alternative, in further embodiments in the first mode of operation, the surge relief valve is open and in the second mode of operation, the surge relief valve is closed.

In addition to one or more of the features described herein, or as an alternative, in further embodiments the first mode of operation is associated with a ground condition of the vehicle and the second mode of operation is associated with a flight condition of the vehicle.

In addition to one or more of the features described herein, or as an alternative, in further embodiments the exhaust bypass conduit is directly connected to the compressor outlet.

In addition to one or more of the features described herein, or as an alternative, in further embodiments a ram air circuit includes at least one heat exchanger fluidly connected to both the first inlet and the second inlet.

In addition to one or more of the features described herein, or as an alternative, in further embodiments the at least one heat exchanger is fluidly connected to the compressor outlet. The at least one heat exchanger is arranged directly downstream from the compressor outlet.

In addition to one or more of the features described herein, or as an alternative, in further embodiments the exhaust bypass conduit is fluidly connected to the compressor outlet at a location upstream from the at least one heat exchanger relative to the flow of the second medium.

In addition to one or more of the features described herein, or as an alternative, in further embodiments the second medium is cooled within the at least one heat exchanger by a cooling medium and both the second medium and the cooling medium are provided to the air conditioning system via the second inlet.

In addition to one or more of the features described herein, or as an alternative, in further embodiments, the second medium is separated into a first portion and a second portion directly downstream from the second inlet.

In addition to one or more of the features described herein, or as an alternative, in further embodiments the first portion of the second medium is provided to the ram air circuit as a cooling medium and the second portion of the second medium is provided to the compressor as the second medium.

In addition to one or more of the features described herein, or as an alternative, in further embodiments the flow of the second medium provided at an outlet of the at least one heat exchanger is mixed with the first medium at a location downstream from the at least one turbine.

In addition to one or more of the features described herein, or as an alternative, in further embodiments the at least one turbine includes a first turbine and a second turbine, and an outlet of the first turbine is fluidly connected to an inlet of the second turbine such that the first turbine and the second turbine are arranged in series.

In addition to one or more of the features described herein, or as an alternative, in further embodiments a water separator arranged between the first turbine and the second turbine relative to a flow of the first medium.

According to an embodiment, a method of operating an air conditioning system of a vehicle includes in a first mode of operation, conditioning a first medium via a cooling medium and via a thermodynamic device, conditioning a second medium via the cooling medium and via the thermodynamic device and exhausting the second medium overboard. A second mode of operation of the air conditioning system includes conditioning the first medium via the cooling medium and via the thermodynamic device, conditioning the second medium via the cooling medium and via the thermodynamic device, and mixing the first medium and the second medium upstream from an outlet of the air conditioning system.

In addition to one or more of the features described herein, or as an alternative, in further embodiments conditioning the first medium via the thermodynamic device includes extracting energy from the first medium via at least one turbine of the thermodynamic device.

In addition to one or more of the features described herein, or as an alternative, in further embodiments conditioning the second medium via the thermodynamic device includes compressing the second medium via a compressor of the thermodynamic device. The compressor is driven by energy extracted from the first medium via the at least one turbine.

In addition to one or more of the features described herein, or as an alternative, in further embodiments receiving a medium at a second inlet and separating the medium into a first portion and a second portion. The first portion is the cooling medium and the second portion is the second medium.

In addition to one or more of the features described herein, or as an alternative, in further embodiments the first mode of operation is associated with a ground condition of the vehicle and the second mode of operation is associated with a flight condition of the vehicle.

In addition to one or more of the features described herein, or as an alternative, in further embodiments transforming the air conditioning system from the first mode of operation to the second mode of operation by closing a surge relief valve.

### DETAILED DESCRIPTION

A detailed description of one or more embodiments of the disclosed apparatus and method are presented herein by way of exemplification and not limitation with reference to the FIG.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the Figure, an example of a schematic diagram of a portion of an environment control system, such as an air conditioning system or pack for example, is depicted according to a non-limiting embodiment. Although the air conditioning system (ACS) or ACS pack 20 is described with reference to an aircraft, alternative applications, such as another vehicle for example, are also within the scope of the disclosure. As shown, the ACS 20 may be configured to receive a first medium A1 at a first inlet 22. In embodiments where the ACS 20 is used in an aircraft application, the first medium A1 may be bleed air, which is pressurized air originating from, i.e., being "bled" from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ACS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. Thus, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight. The ACS 20 may be operable to provide a conditioned form of at least one of the first medium A1 and the second medium A2 to a volume 26 during normal operation. In an embodiment, the ACS 20 is operable to provide a conditioned form of the first medium A1 to the volume 26. In other embodiments, the ACS 20 is operable to provide a conditioned form of a mixture of the first medium A1 and the second medium A2 to the volume 26.

The ACS 20 may include a RAM air circuit 30 including a cooling shell or duct, illustrated schematically at 32, within which one or more heat exchangers are located. The cooling duct 32 can receive and direct a medium through a portion of the ACS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the cooling duct 32 may be referred to as ram heat exchangers. In the illustrated, non-limiting embodiment, the at least one heat exchanger includes a first or primary heat exchanger 34 and a second or secondary heat exchanger 36. Within the ram heat exchangers 34, 36, fresh or outside air for example, acts as a heat sink to cool a medium passing there through, for example the first medium A1 and/or the second medium A2. Although a ram air circuit 30 having only two heat exchangers 34, 36 is illustrated, it should be understood that embodiments having only a single heat exchanger, or alternatively, more than two heat exchangers are also contemplated herein. Further, although the plurality of ram air heat exchangers 34, 36 are illustrated as being arranged in series relative to a flow through the ram air circuit 30, it should be understood that in other embodiments, the plurality of heat exchanger may be arranged in parallel or some combination of series and parallel.

The ACS 20 may additionally include at least one thermodynamic device 40. A thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device 40 include an air cycle machine, a two-wheel air cycle machine, a three-wheel air cycle machine, a four-wheel air cycle machine, etc.

As shown, the thermodynamic device 40 includes a compressor 42 and at least one turbine operably coupled by a shaft 44. A compressor, such as compressor 42, is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc.

In the illustrated, non-limiting embodiment, the thermodynamic device 40 includes a first turbine 46 and a second turbine 48 coupled to the shaft 44. However, embodiments including a single turbine or more than two turbines are also within the scope of the disclosure. A turbine, such as turbine 46 and turbine 48 for example, is a mechanical device that expands a medium and extracts work therefrom (also referred to as extracting energy). This extracted energy is transmitted to the shaft 44 of the turbine 46, 48 and the other components operably coupled thereto, such as the compressor 42 for example.

In the illustrated, non-limiting embodiment, the ACS 20 includes a fan 50. A fan 50 is a mechanical device that can force via push or pull methods air through the cooling shell 32 of the ram air circuit 30, across at least a portion of the ram air heat exchangers 34, 36. The fan 50 may be a component separate from a thermodynamic device 40 and in such embodiments, is driven by any suitable means, such as a motor for example. However, in other embodiments, such as shown in the Figure, the fan 50 may be operably coupled to the shaft 44 of the thermodynamic device 40. In such embodiments, the fan 50 may be driven by energy extracted within the at least one turbine 46, 48.

The elements of the ACS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value. For example, a first valve V1 is operable to control the flow of the first medium A1 from the inlet 22. A second valve V2 may be associated with an exhaust conduit 60 fluidly connected to the compressor outlet, and located upstream from a ram heat exchanger, such as secondary heat exchanger 36 for example. The second valve V2 may be a surge relief valve used to dump flow output from the compressor 42 overboard or to ambient. A position of the surge relief valve V2 may be adjustable to control a flow of the second medium A2 exhausted overboard via the exhaust bypass conduit 60. A third valve V3 may be control a flow of a medium, such as the first medium A1 for example, into a turbine bypass conduit 62 operable to bypass the first turbine 46, a fourth valve V4 may be used to control a flow of a medium, such as the first medium A1, into a dehumidification bypass conduit 64 operable to bypass both the first turbine 46 and the water extractor 52. A fifth valve V5 is associated with and operable to control a flow of a medium, such as the first medium A1 for example, into a thermodynamic bypass conduit 66 to bypass both the first turbine 46 and the second turbine 48 of the thermodynamic device 40. A sixth valve V6 is operable to control a flow of the second medium A2 mixed with the first medium A1 directly upstream from the outlet of the ACS 20.

The ACS 20 illustrated and described herein is operable in a plurality of modes, such as based on a condition of the vehicle. A first mode of the ACS 20 may be associated with operation of the vehicle on the ground. For example, the ACS 20 may be operable in a first mode such as during ground and low altitude flight conditions, for example ground idle, taxi, take-off, and hold conditions. During this first mode, a flow of first medium A1 is received at the first inlet 22. From the first inlet 22, the first medium A1 is provided to an inlet of the primary heat exchanger 34. A flow of cooling medium (identified at A2a) moving through the cooling duct 32 via the fan 50 is provided to the primary heat exchanger 34 to cool the first medium A1. As will be described in more detail below, in an embodiment, the flow of air within the cooling duct 32 is a portion of the second medium A2.

From the outlet of the primary heat exchanger 34, the cool first medium A1 is provided to an inlet of the first turbine 46 of the thermodynamic device 40. Within the first turbine 46, the first medium A1 is expanded and work is extracted therefrom to drive the compressor 42 and the fan 50 via the shaft 44. This extraction of work from the first medium A1 within the turbine 46 creates an expanded first medium A1’.

During its expansion within the first turbine 46, the first medium A1 is further cooled and moisture within the first medium A1 is condensed. In an embodiment, the expanded first medium A1’ provided at the outlet of the first turbine 46 has a temperature close to freezing. Directly downstream from the outlet of the first turbine 46 may be a water extractor 52. Within the water extractor 52, any free moisture in the expanded first medium A1’ is removed. The first turbine 46 and the water extractor 52, in combination, may be considered a mid-pressure water separator.

From an outlet of the water extractor 52, the resulting dry expanded first medium A1’ may be provided to an inlet of the second turbine 48 where it is further expanded and more work is extracted therefrom. This extraction of work from the expanded first medium A1’ within the second turbine 48 creates a further expanded first medium A1”. Accordingly, in an embodiment, during operation in the first mode, the first medium A1 is provided to the first turbine 46 and the second turbine 48 in series. Work extracted from the expanded first medium A1’ within the second turbine 48 may also be used to drive the compressor 42 and/or the fan 50 via the shaft 44. From the second turbine 48, the further expanded first medium A1” may be delivered to one or more loads, such as the cabin 26 for example, via an outlet of the ACS 20.

In the illustrated, non-limiting embodiment, the second medium A2 provided to the ACS 20 via the second inlet 24 is divided directly downstream from the inlet 24 into a first portion A2a and a second portion A2b, respectively. The first portion A2a of the second medium may be provided to the ram air circuit 30 and the second portion A2b of the second medium may be conditioned within the ACS 20 and in some embodiments, may be delivered to one or more downstream loads 26. Although the second medium A2 is illustrated as being split into two flows, it should be understood that in other embodiments, the cooling medium A2a provided to the ram air circuit 30 may be provided from a separate source as the second medium A2b to be conditioned within the ACS 20. For example, the cooling medium A2a may be drawn from a first scoop, and the second medium A2b may originate from a separate, second scoop.

The first portion A2a of the second medium provided to the cooling duct 32 may be drawn therethrough via the fan 50. The first portion A2a of the second medium is operable as a cooling medium configured to absorb heat from one or more mediums passing through the primary heat exchanger 34 and the secondary heat exchanger 36. In the illustrated, non-limiting embodiment, the first portion A2a of the second medium is provided to the secondary heat exchanger 36 and the primary heat exchanger 34 in series, with the primary heat exchanger 34 being arranged downstream from the secondary heat exchanger 36 relative to the flow of the first portion A2a of the second medium. However, embodiments where the secondary heat exchanger 36 is arranged downstream from the primary heat exchanger 34 and embodiments where the primary and secondary heat exchangers 34, 36 are arranged in parallel relative to the flow of the first portion A2a of the second medium are also within the scope of the disclosure. After absorbing heat from the plurality of ram heat exchangers 34, 36, the first portion A2a of the second medium may be exhausted from the ram air circuit 30 overboard.

The second portion A2b of the second medium is provided to an inlet of the compressor 42. The act of compressing the second medium A2 heats it to form a compressed second portion A2b’ of the second medium. As shown, a second, surge relief valve V2 may be arranged within or associated with an exhaust conduit 60 fluidly connected to an outlet of the compressor 42. During operation of the ACS 20 in the first mode, this surge relief valve V2 is open. As a result, at least a portion of the compressed second portion A2b’ of the second medium A2 output from the compressor 42 may be exhausted overboard, outside the vehicle when the surge relief valve V2 is open. In an embodiment, all of the compressed second portion A2b’ of the second medium is exhausted to ambient via the surge relief valve V2. Accordingly, only the first medium A1 may be provided to an outlet of the ACS 20 and to one or more downstream loads 26 during operation in the first mode.

The ACS 20 may also be operable in a second mode. The second mode may be associated with “high-altitude” operation suitable for use during flight conditions such as at high altitude cruise, climb, and descent flight conditions. Operation of the ACS 20 in the high-altitude mode may be similar to operation on the ground. However, during operation in the second mode, the surge relief valve V2 is closed, and therefore the sixth valve V6 is open.

In the second mode of operation, the first medium A1 provided at the first inlet 22 flows to an inlet of the primary heat exchanger 34 where the first medium is cooled by the first portion A2a of the second medium. In an embodiment, during operation of the vehicle in the second mode, the first turbine bypass valve V3 associated with the first turbine 46 is open. Accordingly, the first medium A1 output from the outlet of the primary heat exchanger 34 may be configured to bypass the first turbine 46 and is provided from the primary heat exchanger 34 directly to the water extractor 52. In such embodiments, the first medium A1 at the outlet of the primary heat exchanger 34 has a temperature equal to or close to freezing. Within the water extractor 52, moisture is removed from the first medium A1. From the water extractor 52, the first medium A1 is provided to the second turbine 48. The first medium A1 is expanded within the second turbine 48 and energy is extracted therefrom to form the expanded first medium A1”. The expanded first medium A1” at the outlet of the second turbine 48 may be delivered to one or more downstream loads 26.

It should be appreciated that in other embodiments, the fourth valve V4 may be open such that the first medium A1 output from the primary heat exchanger 34 bypasses both the first turbine 46 and the water extractor 52 via the dehumidification bypass conduit 64, or the fifth valve V5 may be open such that the first medium A1 output from the primary heat exchanger 34 bypasses the first turbine 46, the second turbine 48, and the water extractor 52.

In the second mode, the second medium A2 provided to the ACS 20 via the second inlet 24 is similarly separated into a first portion A2a used as a cooling medium at the ram air circuit 30 and a second portion A2b conditioned within the ACS 20. In the illustrated, non-limiting embodiment, the first portion A2a of the second medium acts as a heat sink to absorb heat from a medium within the secondary heat exchanger 36 and the primary heat exchanger 34. After absorbing heat at the plurality of ram heat exchangers 34, 36, the first portion A2a of the second medium may be dumped overboard from the ram air circuit 30.

The second portion A2b of the second medium is provided to an inlet of the compressor 42. The act of compressing the second medium A2 heats it. Because the surge relief valve V2 is closed, the compressed second portion A2b’ of the second medium output from the compressor 42 is provided to the secondary heat exchanger 36 of the ram air circuit 30. Within the secondary heat exchanger 36, the compressed second portion A2b’ of the second medium is cooled by the first portion A2a of the second medium. With valve V6 open, the resulting cool, compressed second portion A2b’ of the second medium output from the secondary heat exchanger 36 may then be mixed with the expanded first medium A1” at the outlet of the second turbine 48 or at a location downstream therefrom. Accordingly, during flight, the conditioned medium provided to the outlet of the ACS pack 20 may be a mixture of first medium A1 and second medium A2.

It should be understood that although the ACS 20 is illustrated and described herein as having a turbine and a water extractor 52 that in combination form a mid-pressure water separator, embodiments where the ACS 20 alternatively includes a high-pressure water removal system are also within the scope of the disclosure. A high-pressure water removal system may include a condensing heat exchanger and a water separator. In embodiment including a high-pressure water removal system, the flow of the first medium A1 output from the heat exchanger 34 may be provided to the condensing heat exchanger, where the flow is cooled, and then to the water separator. The drier first medium is then expanded within the first turbine 46, and the flow of expanded first medium A1” output from the turbine would form the second pass within the condensing heat exchanger and absorb heat from the upstream first medium A1 therein.

An ACS 20 as illustrated and described herein provides fresh air or outside air in addition to bleed air to one or more the loads 26 of the aircraft during flight. As a result, the bleed air consumption of the ACS 20 is reduced, which in turn lowers the aircraft fuel burn.

The term "about" is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An air conditioning system of a vehicle comprising:
a first inlet for receiving a first medium;
a second inlet for receiving a second medium;
a thermodynamic device fluidly connected to both the first inlet and the second inlet, the thermodynamic device including a compressor and at least one turbine operably coupled by a shaft, the compressor having a compressor outlet;
an exhaust bypass conduit fluidly connected to the compressor outlet; and
a surge relief valve associated with the exhaust bypass conduit, a position of the surge relief valve being adjustable to control a flow of the second medium exhausted overboard via the exhaust bypass conduit.

2. The air conditioning system of claim 1, further comprising an outlet, wherein in a first mode of operation, only the first medium is provided to the outlet and in a second mode of operation, a mixture of both the first medium and the second medium is provided to the outlet.

3. The air conditioning system of claim 2, wherein in the first mode of operation, the surge relief valve is open and in the second mode of operation, the surge relief valve is closed.

4. The air conditioning system of claim 2, wherein the first mode of operation is associated with a ground condition of the vehicle and the second mode of operation is associated with a flight condition of the vehicle.

5. The air conditioning system of claim 1, wherein the exhaust bypass conduit is directly connected to the compressor outlet.

6. The air conditioning system of claim 1, further comprising a ram air circuit including at least one heat exchanger, the at least one heat exchanger being fluidly connected to both the first inlet and the second inlet.

7. The air conditioning system of claim 6, wherein the at least one heat exchanger is fluidly connected to the compressor outlet, the at least one heat exchanger being arranged directly downstream from the compressor outlet.

8. The air conditioning system of claim 7, wherein the exhaust bypass conduit is fluidly connected to the compressor outlet at a location upstream from the at least one heat exchanger relative to the flow of the second medium.

9. The air conditioning system of claim 6, wherein the second medium is cooled within the at least one heat exchanger by a cooling medium, wherein both the second medium and the cooling medium are provided to the air conditioning system via the second inlet.

10. The air conditioning system of claim 6, wherein directly downstream from the second inlet, the second medium is separated into a first portion and a second portion.

11. The air conditioning system of claim 10, wherein the first portion of the second medium being provided to the ram air circuit as a cooling medium, and the second portion of the second medium being provided to the compressor as the second medium.

12. The air conditioning system of claim 6, wherein the flow of the second medium provided at an outlet of the at least one heat exchanger is mixed with the first medium at a location downstream from the at least one turbine.

13. The air conditioning system of claim 1, wherein the at least one turbine includes a first turbine and a second turbine, an outlet of the first turbine being fluidly connected to an inlet of the second turbine such that the first turbine and the second turbine are arranged in series.

14. The air conditioning system of claim 13, further comprising a water separator arranged between the first turbine and the second turbine relative to a flow of the first medium.

15. A method of operating an air conditioning system of a vehicle, the method comprising:
in a first mode of operation:
conditioning a first medium via a cooling medium and via a thermodynamic device;
conditioning a second medium via the cooling medium and via the thermodynamic device;
exhausting the second medium overboard;
in a second mode of operation:
conditioning the first medium via the cooling medium and via the thermodynamic device;
conditioning the second medium via the cooling medium and via the thermodynamic device; and
mixing the first medium and the second medium upstream from an outlet of the air conditioning system.

16. The method of claim 15, wherein conditioning the first medium via the thermodynamic device includes extracting energy from the first medium via at least one turbine of the thermodynamic device.

17. The method of claim 16, wherein conditioning the second medium via the thermodynamic device includes compressing the second medium via a compressor of the thermodynamic device, the compressor being driven by energy extracted from the first medium via the at least one turbine.

18. The method of claim 15, further comprising:
receiving a medium at a second inlet; and
separating the medium into a first portion and a second portion, wherein the first portion is the cooling medium and the second portion is the second medium.

19. The method of claim 15, wherein the first mode of operation is associated with a ground condition of the vehicle and the second mode of operation is associated with a flight condition of the vehicle.

20. The method of claim 15, further comprising transforming the air conditioning system from the first mode of operation to the second mode of operation by closing a surge relief valve.
